(19) United States
(12) Patent Application Publication
(10) Pub. No.: US 2009/0115979 A1
(43) Pub. Date: May 7, 2009

(54) Immersion lithography apparatus

(75) Inventors: Marcus Theodoor Wilhelmus Van Der Heijden, Dilsen-Stokkem (Elen) (BE); Ronald Harm Gunther Kramer, Hooge Mierde (NL); Frederik Johannes Van Den Bogaard, Eindhoven (NL); Peter Gerardus Hubertus Maria Janssen, Meijel (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/289,537

(22) Filed: Oct. 29, 2008

Related U.S. Application Data
(60) Provisional application No. 61/000,917, filed on Oct. 30, 2007.

(51) Int. Cl. G03B 27/62

(52) U.S. Cl. 355/30

(57) ABSTRACT

A sampler, sample holder and an immersion lithographic apparatus comprising a sampler is disclosed. In an embodiment, a sampler is provided to collect particles in an immersion system of a lithographic apparatus. The sampler comprises a holder base having a collector surface. The collector surface is configured to collect and store contaminants. The sampler may be located on a surface of the immersion system so as to collect sample particles by contact of the collector surface with a liquid or with a surface of the immersion system. The sampler may be removable from the immersion lithographic apparatus for inspection.

This application claims priority and benefit under 35 U.S.C. §119(e) to U.S. Provisional Patent Application No. 61/000,917, filed Oct. 30, 2007, the foregoing application incorporated herein in its entirety by reference.

### FIELD

The present invention relates to a sampler to collect sample contaminants, an immersion lithographic apparatus comprising a sampler, and method of using a sampler in an immersion lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. The liquid may be distilled water, although another liquid could be used. The description herein references a liquid. However, another fluid may be suitable, particularly a wetting fluid, incompressible fluid and/or a fluid with a higher refractive index than air, desirably a higher refractive index than water. The point of this is to enable imaging of smaller features since the exposure radiation will have a shorter wavelength in the liquid. (The effect of the liquid may also be regarded as increasing the effective NA of the system and also increasing the depth of focus.) Other immersion liquids have been proposed, including water with solid particles (e.g. quartz) suspended therein.

However, submersing the substrate or substrate and substrate table in a bath of liquid (see, for example, U.S. Pat. No. 4,509,852) means that there is a large body of liquid that must be accelerated during a scanning exposure. This requires additional or more powerful motors and turbulence in the liquid may lead to undesirable and unpredictable effects.

One of the solutions proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application no. WO 99/49504. As illustrated in FIGS. 2 and 3, liquid is supplied by at least one inlet IN onto the substrate, preferably along the direction of movement of the substrate relative to the final element, and is removed by at least one outlet OUT after having passed under the projection system. That is, as the substrate is scanned beneath the element in a −X direction, liquid is supplied at the +X side of the element and taken up at the −X side. FIG. 2 shows the arrangement schematically in which liquid is supplied via inlet IN and is taken up on the other side of the element by outlet OUT which is connected to a low pressure source. In the illustration of FIG. 2 the liquid is supplied along the direction of movement of the substrate relative to the final element, though this does not need to be the case. Various orientations and numbers of in- and out-lets positioned around the final element are possible; one example is illustrated in FIG. 3 in which four sets of an inlet with an outlet on either side are provided in a regular pattern around the final element.

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

One problem encountered with immersion lithographic machines is the occurrence of contaminating particles. There are many sources of these particles. Some of these are now described, and the particle sources are not limited to this list. The particles may be present in the immersion liquid to the immersion system. The particles may be created in the immersion system between the surfaces of adjacent moving components of the immersion system or in the event of damage caused to a liquid supply apparatus or a substrate or a substrate table. Such damage may be caused, for example, by collision between components of the immersion system. The particles may be present in parts of the lithographic apparatus which are not part of the immersion system and directed into the immersion liquid by, for example, moving liquid within the apparatus. The particles may be created in the immersion liquid, for example, by crystallization from dissolved contaminants present in the immersion system or interaction between the immersion system and the material comprising the surfaces of the immersion system. Some particles may be flakes derived from the resist or a topcoat. A component of the immersion system may have a coating that deteriorates. The causes of deterioration may be one or more of the following: age, use, interaction with the immersion liquid, or interaction with UV radiation used as the exposure source. As the coating deteriorates it is liable to break up, releasing particles into the immersion liquid.

The presence of a particle in the immersion system may cause a defect to occur during exposure process when the particle comes between the projection system and the substrate being exposed. It is therefore desirable to reduce optimally the presence of particles in the immersion system.

### SUMMARY

Many types of immersion lithography apparatus have in common that immersion liquid is provided to a space between a final element of the projection system and the substrate. That liquid is usually removed from that space. For example such removal can be, but is not limited to, for cleaning of the immersion liquid or cleaning of the immersion system. Such cleaning can be, for example, to remove particles or for temperature conditioning of the immersion liquid.

Monitoring of contaminants is thus beneficial during installation, use and servicing of an immersion lithographic apparatus. A ‘sample pen’ 60 as shown in FIGS. 6a and 6b may be used. The sample pen comprises a cylindrical body 62 suitable for hand manipulation. At one end of the pen body is a removable cap 64 that is replaceable. Attached to the end of body, within the cap, is a protuberance which has a carbon sticker 68 (a thin graphite sheet) located at its tip 66. A carbon sticker is a reliable sample medium. It is desirable for the carbon sticker 68 to have a holder as otherwise the carbon sticker 68 would break because it is fragile. If it is not manipulated using such a holder, it may be difficult to manipulate. In use, the cap 64 of the pen 60 is removed (as shown in FIG. 6b) and the tip 66 is placed in contact with a location being sampled. The cap 64 is then replaced. The pen 60 may be examined using an examination tool, for example a scanning electron microscope (a ‘SEM’), energy dispersive X-ray analysis (‘EDX’) and/or infrared analysis to examine and inspect the sampled particles. A SEM may be used to determine the amount of particles, an EDX analysis may be used to identify inorganic components of the particles and infrared analysis may be used to identify organic contaminants. However, typical on-site inspection tools located at a fabrication plant is dimensioned to a height of 1 mm and there is little tolerance. So for examination and inspection, the sample may need to be shipped to an off-site inspection tool. Examination may be delayed, so making the detection and evaluation of the contamination a long time-consuming process.

An immersion lithographic tool is dimensioned to immerse at least a portion of a substrate. The dimensions of the hand-held sample pen 60 may be unsuitable to take a sample in an immersion lithographic tool for on-site inspection.

The pen 60 may be used a single time. During installation, operation and servicing, many samples may be taken. In this way the extent and location of contamination may be detected and determined. The relative contamination of different locations of the immersion system may be studied. The change of contamination with time can be observed, for example with extended use or ensure effective servicing or repair.

It is desirable, for example, to provide an inexpensive sampler which may be used within the immersion system and an on-site inspection tool.

According to an aspect of the invention, there is provided a sampler configured to collect sample contaminants in a lithographic apparatus. The sampler comprises a holder base having a collector surface. The collector surface is configured to collect and store contaminants. The sampler may have the shape and/or dimension of a substrate for use in exposure by a lithographic apparatus. The sampler may have the height of a substrate for use in exposure by a lithographic apparatus. The holder base may comprise a collector layer. The collector surface may be a surface of the collector layer.

According to an aspect of the invention, there is provided a sample holder configured to releaseably hold a sampler. The sampler is configured to collect sample contaminants in a lithographic apparatus. The sampler comprises a holder base having a collector surface. The collector surface is configured to collect and store contaminants.

According to an aspect of the invention, there is provided an immersion lithographic apparatus comprising an immersion system and a removable sampler configured collect particles in the immersion system. The sampler comprises a holder base having a collector surface. The collector surface is configured to collect and store contaminants. The sampler is removably located on a surface of the immersion system so as to collect sample particles by contact of the collector surface with a liquid or with a surface of the immersion system, or to collect falling or gas-borne particles. On contact of the collector surface with a surface of the immersion system, a force may be applied to sampler so that particles become attached to the collector surface. The immersion system may comprise a plurality of samplers. The samplers may be located on different surfaces of the immersion system. The liquid may be immersion liquid. The immersion system may comprise a substrate table configured to hold a substrate and liquid supply system configured to supply liquid between a projection system and the substrate table or substrate. The sampler may be dimensioned to fit between the liquid supply system and the substrate table in the absence of a substrate.

According to an aspect of the invention, there is provided a lithographic apparatus comprising: a substrate table configured to hold a substrate; a projection system configured to project a patterned beam of radiation onto a target portion of the substrate; and a sampler located on a surface of the apparatus, the sampler comprising a holder base having a collector surface, the collector surface configured to collect and store particles. The holder base may have a collector layer, where the collector surface is a surface of the collector layer. The holder base may hold the collector layer.

According to an aspect of the invention, there is provided a method of taking particle samples in an immersion lithographic apparatus, the method comprising: positioning a particle sampler having the height of a substantially planar substrate in or on an immersion lithographic apparatus, the sampler comprising a holder base having a collector surface, the collector surface configured to collect and store particles, wherein in positioning the sampler the collector surface: is in contact with a surface of the immersion lithographic apparatus or liquid of the immersion lithographic apparatus or is configured to collect falling or gas-borne particles; and removing the sampler from the immersion lithographic apparatus to inspect if any particles were collected on the collector surface. The holder base may comprise a collector layer, the collector surface being a surface of the collector layer.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according an embodiment of the invention;

FIGS. 2 and 3 depict an embodiment of a liquid supply system for use in a lithographic projection apparatus;

FIG. 4 depicts an embodiment of a liquid supply system for use in a lithographic projection apparatus;

FIG. 5 depicts an embodiment of a liquid supply system;

FIGS. 6a and 6b depict an embodiment of a particle sampler;

FIG. 7 depicts an embodiment of a drain location around the edge of a substrate;

FIGS. 8a-c depict an embodiment of parts of a liquid supply system;

FIG. 9 depicts an embodiment of particle sampler according to an embodiment of the invention;

FIGS. 10a and 10b depict an embodiment of a particle sampler according to an embodiment of the invention; and

FIGS. 11a, 11b and 11c depict securing apparatus to secure a sampler to a sample holder.

### DETAILED DESCRIPTION

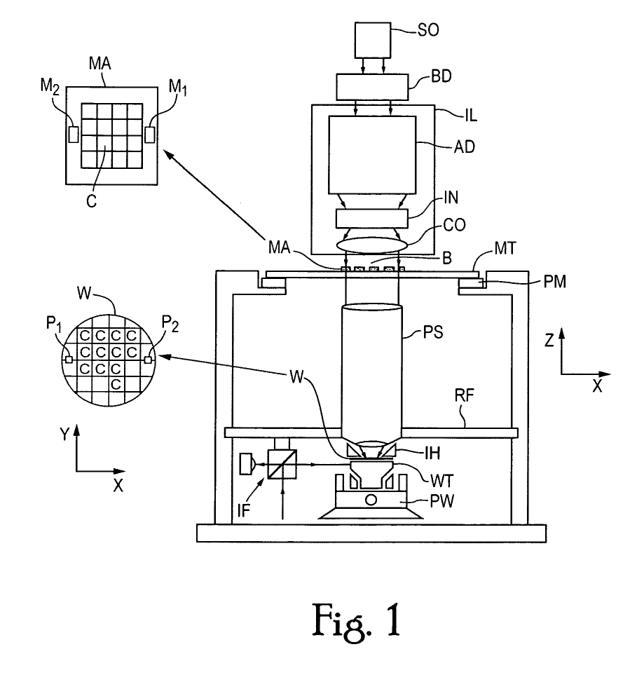

FIG. 1 schematically depicts an embodiment of lithographic apparatus suitable for use with an embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS, support on a frame RF, configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as required. The support structure MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device support structures). In such “multiple stage” machines the additional tables and/or support structures may be used in parallel, or preparatory steps may be carried out on one or more tables and/or support structures while one or more other tables and/or support structures are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

An immersion lithography solution with a localized liquid supply system is shown in FIG. 4. Liquid is supplied by two groove inlets IN on either side of the projection system PL and is removed by a plurality of discrete outlets OUT arranged radially outwardly of the inlets IN. The inlets IN and OUT can be arranged in a plate with a hole in its centre and through which the projection is project. Liquid is supplied by one groove inlet IN on one side of the projection system PL and removed by a plurality of discrete outlets OUT on the other side of the projection system PL, causing a flow of a thin film of liquid between the projection system PL and the projection system PL and removed by a plurality of discrete outlets OUT on the other side of the projection system PL, causing a flow of a thin film of liquid between the projection system PL and the substrate W. The choice of which combination of inlet IN and outlets OUT to use can depend on the direction of movement of the substrate W (the other combination of inlet IN and outlets OUT being inactive).

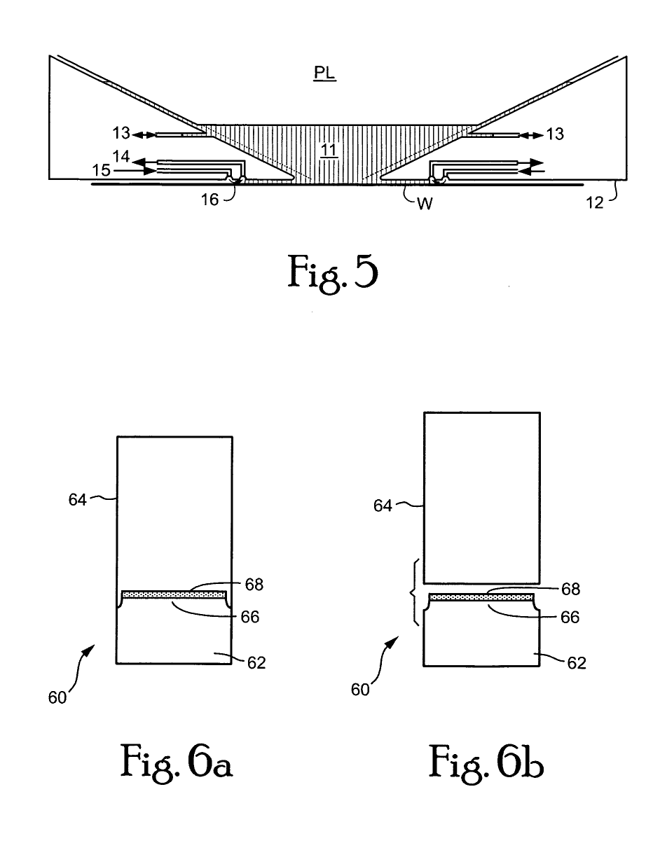

Another immersion lithography solution with a localized liquid supply system solution which has been proposed is to provide the liquid supply system with a liquid confinement structure (or so-called immersion hood) which extends along at least a part of a boundary of the space between the final element of the projection system and the substrate table. Such a solution is illustrated in FIG. 5. The liquid confinement structure is substantially stationary relative to the projection system in the XY plane though there may be some relative movement in the Z direction (in the direction of the optical axis). A seal may be formed between the liquid confinement structure and the surface of the substrate.

Referring to FIG. 5, a liquid confinement structure 12 forms a contactless seal to the substrate around the image field of the projection system so that liquid is confined to fill a space 11 between the substrate surface and the final element of the projection system. The space 11 is formed by a liquid confinement structure 12 positioned below and surrounding the final element of the projection system PL. Liquid is brought into the space below the projection system and within the liquid confinement structure 12 through, for example, liquid inlet 13. Liquid may also or alternatively be removed through inlet 13. The liquid confinement structure 12 extends a little above the final element of the projection system and the liquid rises above the final element so that a buffer of liquid is provided. The liquid confinement structure 12 has an inner periphery that at the upper end, in an embodiment, closely conforms to the shape of the projection system or the final element thereof and may, e.g., be round. At the bottom, the inner periphery closely conforms to the shape of the image field, e.g., rectangular though this need not be the case.

The liquid is confined in the reservoir by a gas seal 16 between the bottom of the liquid confinement structure 12 and the surface of the substrate W. The gas seal is formed by gas, e.g. air or synthetic air but, in an embodiment, N₂ or another inert gas, provided under pressure via inlet 15 to the gap between liquid confinement structure 12 and substrate and extracted via first outlet 14. The overpressure on the gas inlet 15, vacuum level on the first outlet 14 and geometry of the gap are arranged so that there is a high-velocity gas flow inwards that confines the liquid. Such a system is disclosed in United States patent application publication no. US 2004-0207824.

Other solutions are possible and one or more embodiments of the present invention are equally applicable to those. For example, in place of the gas seal 16 it is possible to have a single phase extractor which only extracts liquid. Radially outwardly of such a single phase extractor could be one or more features to produce a gas flow to help contain the liquid in the space. One such type of feature might be a so-called gas knife in which a thin jet of gas is directed downwards onto the substrate W. During scanning motion of the substrate under the projection system and the liquid supply system, hydrostatic and hydrodynamic forces may be generated which result in pressures on the liquid downwards towards the substrate.

With a localized area liquid supply system, the substrate W is moved under the projection system PL and the liquid supply system. Further, a sensor on the substrate table WT and/or a shutter member may be moved under the liquid supply system. The shutter member enables, for example, substrate swap to take place. The shutter member may be part of the substrate table WT. It may be removable from the substrate table and be referred to as a dummy substrate or a so-called closing plate. During substrate swap, for example, an edge of the substrate W will pass under the space 11 and liquid may leak into the gap between the substrate W and substrate table WT. This liquid may be forced in under hydrostatic or hydrodynamic pressure or the force of a gas knife or other gas flow creating device.

A drain may be provided around the edge of a substrate W or another object placed on the substrate table. Such an object may include, but is not limited to, a closing plate used to maintain liquid in the liquid supply system by being attached to the bottom of the liquid supply system during, for example, substrate swap and/or one or more sensors. Thus, any reference to the substrate W should be considered to be synonymous with any such other object, including a sensor or closing plate.

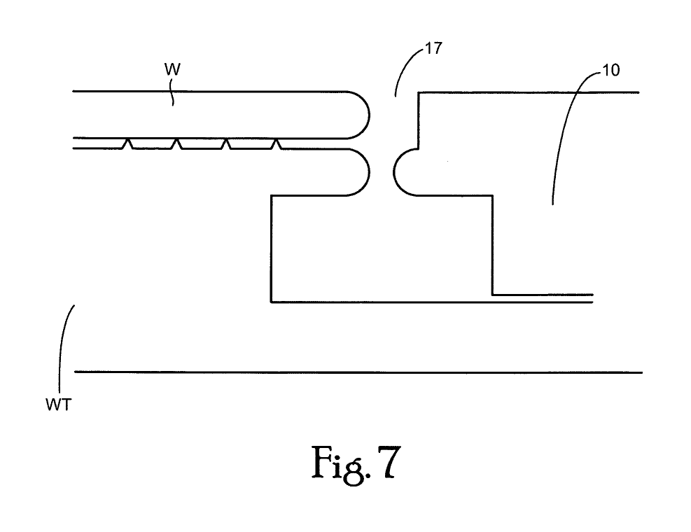

FIG. 7 illustrates an embodiment of drain configuration. FIG. 7 is a cross-section through a substrate table WT and a substrate W. A drain 10 is provided around the outer edge of the substrate W where a gap 17 between the substrate W and the substrate table WT exists. The drain 10 may extend around the periphery of the substrate W. In an embodiment, the drain 10 may only extend around part of a periphery of the substrate W. The drain 10 may formed within the substrate table WT.

A top portion of the substrate table WT, near an inlet to the drain 10, is constructed and arranged such that its top surface will be substantially parallel and co-planar with the top surface of the substrate W when the substrate W is placed on the substrate table WT. This is to help ensure that when an edge of the substrate W is being imaged or when the substrate table WT passes under the projection system to bring the substrate W under the projection system for the first time or to move the substrate W out from under the projection system following imaging, and the relative position of the liquid supply system passes from the top surface of the substrate table WT to the top surface of the substrate W or vice versa, leaking of liquid into gap 17 will be reduced or minimized. However, some liquid will inevitably enter the gap 17. The gap 17 may be provided with features such as a low pressure source in order to remove liquid which enters the gap 17.

An embodiment of the present invention will be described below in relation to an immersion system optimized for supplying an immersion liquid. However, an embodiment of the present invention is equally applicable for use with an immersion system that uses a fluid supply system supplying a fluid other than a liquid as the immersion medium.

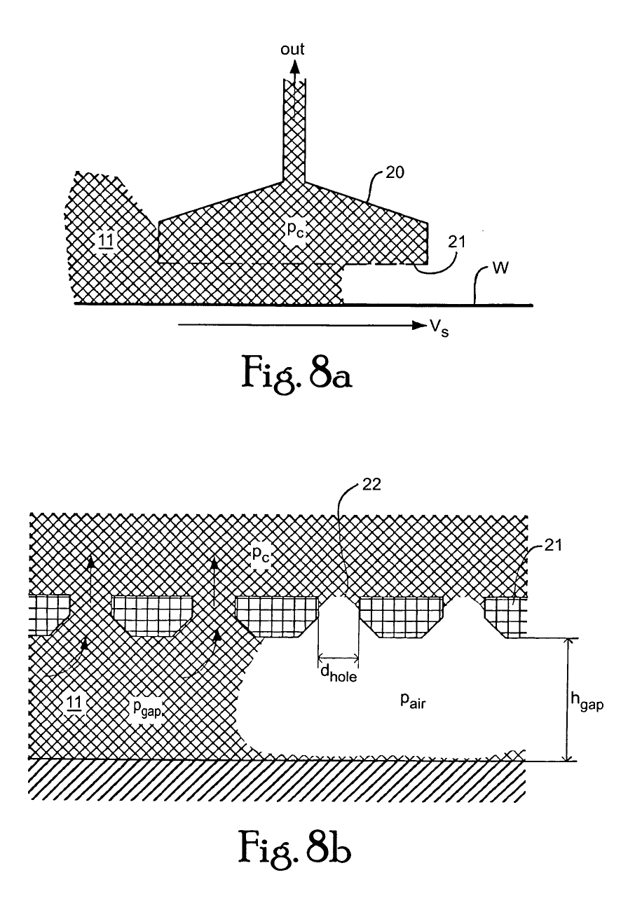

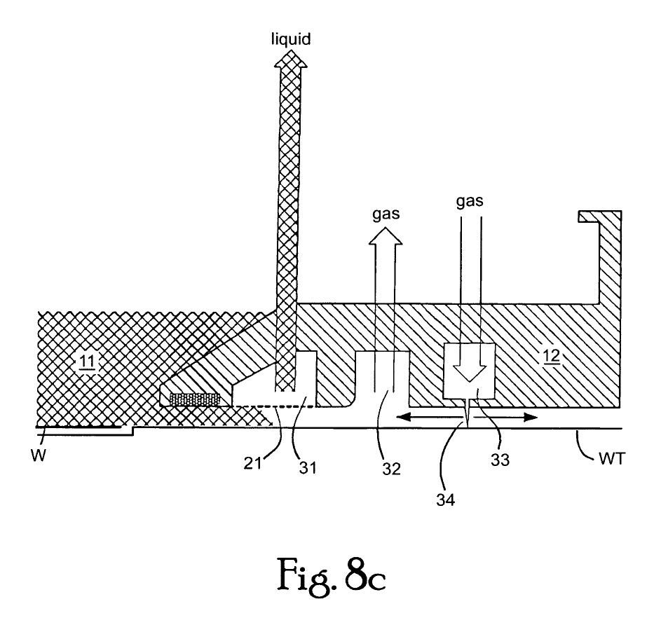

FIGS. 8a and 8b, the latter of which is an enlarged view of part of the former, illustrate a liquid removal device 20 which may be used in an immersion system to remove liquid between the immersion hood IH and the substrate W. The liquid removal device 20 comprises a chamber which is maintained at a slight underpressure p_{c} and is filled with the immersion liquid. The lower surface of the chamber is formed of a porous member 21 having a plurality of small holes, e.g. of diameter dₕₒₗₑ in the range of 5 μm to 50 μm. The lower surface is maintained at a gap height h_{gap} of less than 1 mm, desirably in the range of 50 μm to 300 μm above a surface from which liquid is to be removed, e.g. the surface of a substrate W. The porous member 21 may be a perforated plate or any other suitable structure that is configured to allow the liquid to pass therethrough. In an embodiment, porous member 21 is at least slightly liquidphilic (i.e., for water, hydrophilic), i.e. having a contact angle of less than 90° to the immersion liquid, e.g. water.

Such a liquid removal device can be incorporated into many types of liquid confinement structure 12/immersion hood IH. One example is illustrated in FIG. 8c as disclosed in United States patent application publication no. US 2006-0038968. FIG. 8c is a cross-sectional view of one side of the liquid confinement structure 12, which forms a ring (as used herein, a ring may be circular, rectangular or any other shape and may be continuous or discontinuous) at least partially around the exposure field of the projection system PS (not shown in FIG. 8c). In this embodiment, the liquid removal device 20 is formed by a ring-shaped chamber 31 near the innermost edge of the underside of the liquid confinement structure 12. The lower surface of the chamber 31 is formed by a porous member 30 (e.g., perforated plate 21), as described above. Ring-shaped chamber 31 is connected to a suitable pump or pumps to remove liquid from the chamber and maintain the desired underpressure. In use, the chamber 31 is full of liquid but is shown empty here for clarity.

Outward of the ring-shaped chamber 31 may be a gas extraction ring 32 and a gas supply ring 33. The gas supply ring 33 may have a narrow slit in its lower part and is supplied with gas, e.g. air, artificial air or flushing gas, at a pressure such that the gas escaping out of the slit forms a gas knife 34 which is, in an embodiment, downwardly directed. The gas forming the gas knife is extracted by a suitable vacuum pump connected to the gas extraction ring 32 so that the resulting gas flow drives any residual liquid inwardly where it can be removed by the liquid removal device and/or the vacuum pump, which should be able to tolerate vapor of the immersion liquid and/or small liquid droplets. However, since the majority of the liquid is removed by the liquid removal device 20, the small amount of liquid removed via the vacuum system does not cause an unstable flow which may lead to vibration.

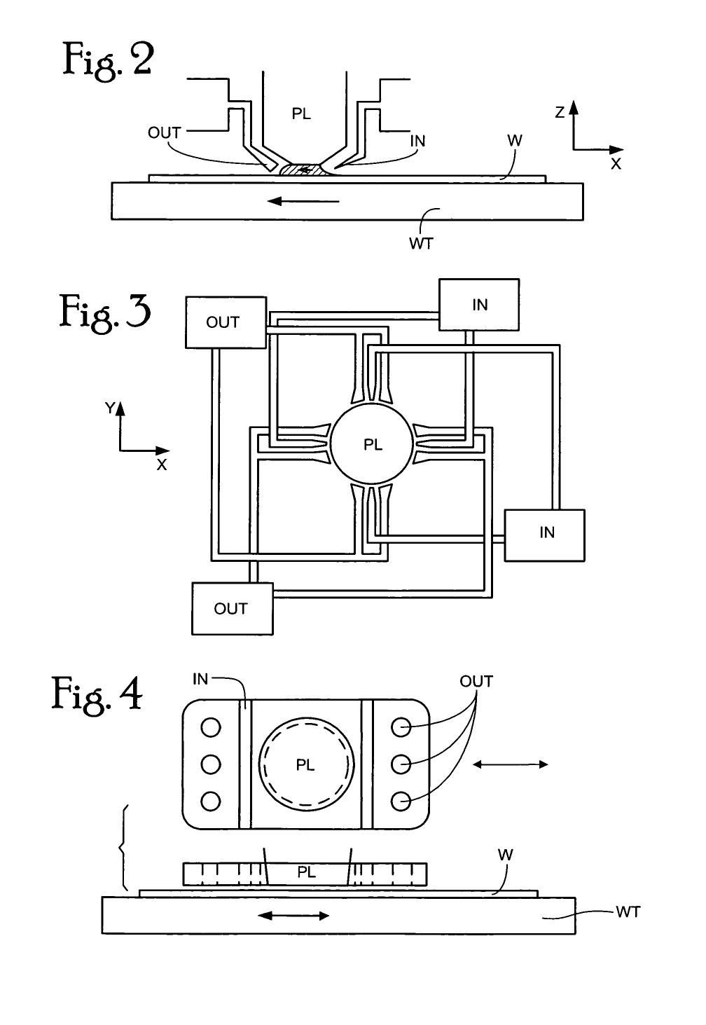

While the chamber 31, gas extraction ring 32, gas supply ring 33 and other rings are described as rings herein, it is not necessary that they surround the exposure field or be complete. One or more of them may be continuous or discontinuous. In an embodiment, such inlet(s) and outlet(s) may simply be any annular shape such as circular, rectangular or other type of elements extending partially along one or more sides of the exposure field, such as for example, shown in FIGS. 2, 3 and 4.

In the apparatus shown in FIG. 8c, most of the gas that forms the gas knife is extracted via gas extraction ring 32, but some gas may flow into the environment around the immersion hood and potentially disturb the interferometric position measuring system IF. This can be prevented by the provision of an additional gas extraction ring outside the gas knife (not illustrated).

Further examples of how such a single phase extractor can be used in an immersion hood or liquid confinement system or liquid supply system can be found, for example in European patent application publication no. EP 1,628,163 and United States patent application publication no. US 2006-0158627. In most applications the porous member will be on an underside of the liquid supply system and the maximum speed at which the substrate W can move under the projection system PS is at least in part determined by the efficiency of removal of liquid through the porous member 21.

A single phase extractor may also be used in a two phase mode in which both liquid and gas are extracted (say 50% gas, 50% liquid). The term single phase extractor is not intended herein to be interpreted only as an extractor which extracts one phase, but more generally as an extractor which incorporates a porous member through which gas and/or liquid is/are extracted. In an embodiment, the gas knife (i.e. the gas supply ring 33) may be absent.

The above mentioned single phase extractor (as well as other types) can be used in a liquid supply system which supplies liquid to only a localized area of the top surface of the substrate. Furthermore, such a single phase extractor may also be used in other types of immersion apparatus. The extractor may be used for an immersion liquid other than water. The extractor may be used in a so-called “leaky seal” liquid supply system. In such a liquid supply system, liquid is provided to the space between the final element of the projection system and the substrate. That liquid is allowed to leak from that space radially outwardly. For example, an immersion hood or liquid confinement system or liquid supply system is used which does not form a seal between itself and the top surface of the substrate or substrate table, as the case may be. The immersion liquid may only be retrieved radially outwardly of the substrate in a “leaky seal” apparatus. The comments made in relation to a single phase extractor may apply to other types of extractor, for example an extractor without a porous member. Such an extractor may be used as a two phase extractor to extract both liquid and gas.

An embodiment of the present invention will be described in relation to a lithographic apparatus having an immersion system with a liquid handling system and drain as described in the aforementioned figures. However, it will be apparent that an embodiment of the present invention can be applied to any sort of immersion apparatus. In particular, an embodiment of the present invention may be applicable to any immersion lithographic apparatus in which defectively is a problem and which is reduced optimally and desirably minimized. The systems and components described in the earlier passages of the description are thus example systems and components. An embodiment of the invention may apply to other features of the immersion system which include, but is not limited to, a cleaning system and a cleaning tool for in-line and off-line implementations; the liquid supply and liquid retrieval systems such as an ultra pure water supply system; and the gas supply and removal systems (e.g. a vacuum pump).

FIG. 9 shows an embodiment of a sampler 90 according to an embodiment of the present invention. The sampler 90 may comprise a collector layer 92 and a holder base 94 (e.g., a holder layer). Desirably, the holder base is a layer. The collector layer 92 and holder base 94 may be secured together, desirably by adhesive. The adhesion may be achieved by applying a layer of glue between the collector layer 92 and holder base 94. Alternatively or additionally, the collector layer 94 may be a sticker with a pre-applied adhesive layer.

The holder base 94 may be made of any material not present in the immersion system. Having a sampler 90 made of material present in the immersion system means that detection of particles derived from the immersion system is difficult. The sampler 90 as well as the immersion system would be a likely source of detected particles made of the material of interest. For example, many components of the immersion system are made of aluminum. Aluminum is therefore a material which it is desirable to detect; it is therefore desirable that no component of the sampler 90, such as the holder base 94, is made of aluminum. The holder base 94 may be desirably made of a material comprising silicon, such as crystalline silicon or glass, or any material with a conductive surface. The material used to make the holder base 94 may be insulating, in which case the layer has a coating made of a conductive material (such a surface is pre-coated).

The collector layer 92 may be made of carbon. The collector layer 92 may be a carbon sticker applied to the holder, for example as supplied by Agar Scientific Ltd. or Arizona Carbon Foil Co. Inc. Carbon is used because loose particles present in the immersion liquid or on a sampled surface readily adhere to a portion of a sampling surface 96 of the carbon. However, additionally or in the alternative, the sampler 90 may have a collector surface 96 which may be a surface of the collector layer 92, or of the holder base 94. In one embodiment, the sampler may be made of only one layer having a collector surface 96. The collector surface 96 of these embodiments may be made of a material other than carbon, such as silicon, to which particles may become attached to the collector surface. The properties of the layer to collect particles of a certain size and/or material may be determined by selecting the material used for the collector surface. A collector surface made of silicon would collect smaller particles than a surface made of carbon. The surface would hold particles by means of gravity and/or van de Waals forces. So a collector surface may be selected to collect particles having certain properties. In the remainder of the description, a sampler having a collector layer 92 and holder base 94 will be described. The description may equally apply to a sampler 90 having a collector surface 96 in the absence of a collector layer 94.

The sampler 90 may be used to collect samples of contaminating particles from different locations of the immersion system. The locations may include one or more specific surfaces of an immersion system component. The contaminating particles may be located in a fluid flowing within the immersion system. Such a fluid includes the immersion liquid or a gas which may be supplied from a gas knife. The sampler 90 may be positioned to collect particles borne by one or more of these fluids.

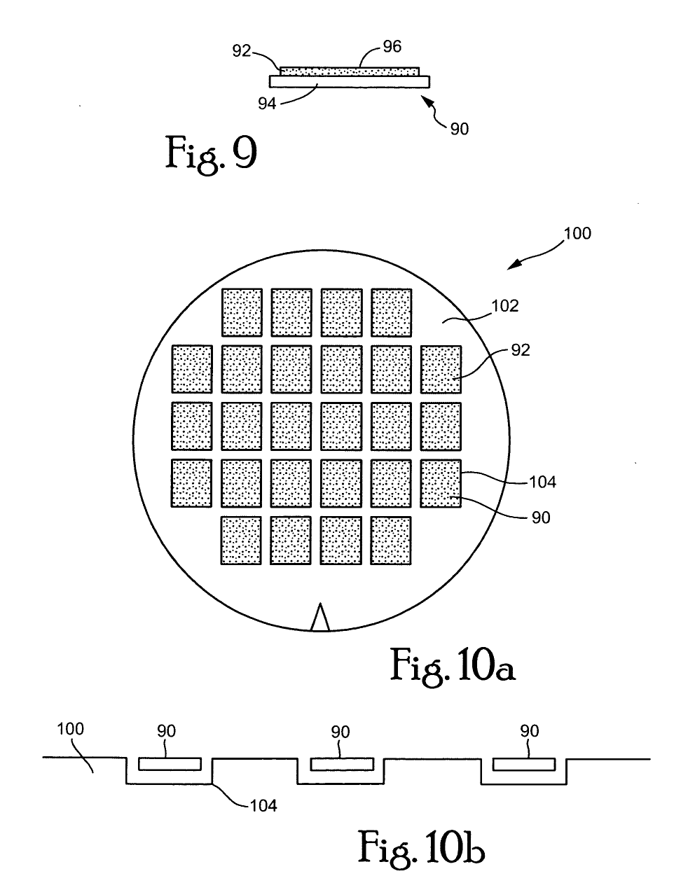

Locations of the immersion system components to or at which the sampler 90 may be located include, but is not limited to, the surface of the substrate table, the underside of the immersion hood IH, the upper surface of the liquid confinement structure 12, the final projection element PL (out of the optical axis). Example locations on the substrate table WT include: within a recess shaped to receive a substrate W, a portion of the substrate table WT co-planar with the upper surface of a substrate W when present, or adjacent to a sensor located on the substrate table. For the sampler 90 to be located in the substrate recess, the sampler 90 may be sized to fit in place of the substrate W under the bottom surface of the liquid confinement structure 12, as described below with reference to FIG. 10a. In this position a top surface 102 of the sampler 90 and substrate table WT may be substantially co-planar and parallel.

There is a gap between the sampler 90 and the undersurface of the liquid confinement structure 12 which may be generally kept at a distance of below 1 mm. In the specific example of the FIG. 8 liquid supply system, the gap is kept to between 100 μm and 500 μm, desirably between 100 μm and 200 μm. To achieve this, the sampler 90 has a height substantially the same as or less than the height of a substrate. This height may be about or less than 1 mm. In an embodiment the sampler is sized and shaped to be easily held and moved by a user. It may be possible to hold a sampler 90 without a user touching a sampling surface 96 of the collector layer 92.

Having the sampler 90 dimensioned to the height of a substrate desirably permits inspection of the sampler 90 after sample collection using an on-site inspection tool. Such an inspection tool is intended for on-site inspection of sample substrates during the lithographic process. The tool is therefore set up and configured to be readily used. The tool is set for inspecting a substrate. Thus having a sampler 90 which may used for such an inspection tool saves time that would otherwise be used to inspect the sampler 90 with a general, off-site inspection tool, as discussed above. The sampler 90 may have a plurality of collector regions. Each sampler 90 may be sized so that a major surface of the sampler has an area less than the surface area of a major surface of a substrate for use in exposure by a lithographic apparatus.

In an embodiment, a sample holder 100 may be provided as shown in FIGS. 10a and 10b. The holder 100 may have the shape and dimensions of a substrate. The sample holder 100 may be substantially circular. It may have a diameter of 200 mm or 300 mm. The sample holder 100 may comprise silicon (such as crystalline silicon or glass or an insulator substantially comprising silicon) and it may be made from a substrate.

The sample holder 100 may have a plurality of recesses 104, for example twenty-six, as shown in FIG. 10a. The recesses 104 may each have a regular shape and they may be similar in shape to each other to facilitate efficient use of the surface area of a side of the holder 100 to accommodate as many recesses 104 as possible. These recesses 104 may be formed by etching a wafer. In an embodiment, the holder 100 may be formed by machining or by molding during the formation of the holder 100.

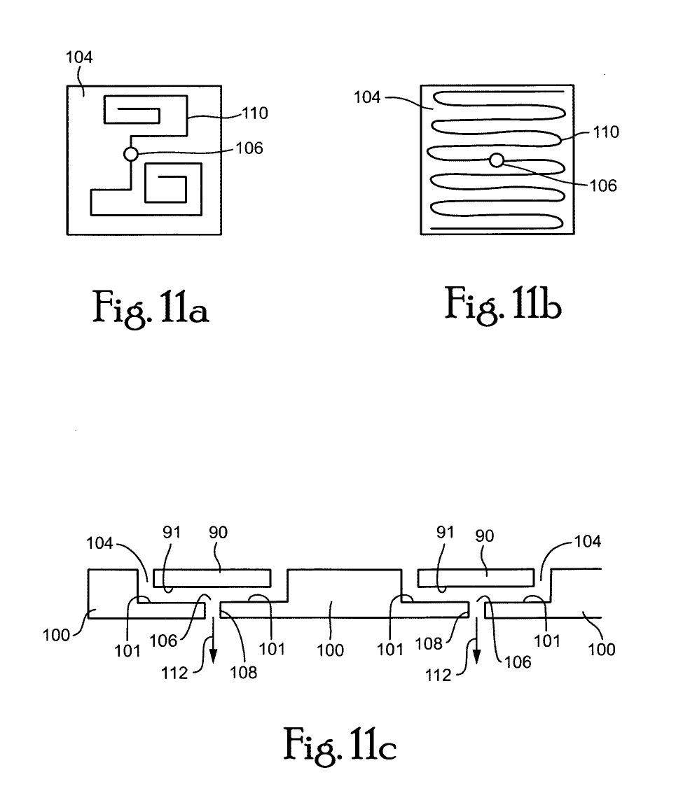

Each recess 104 is shaped and sized to accept a sampler 90. In an embodiment, each collector is secured to a holder base 94 which is in turn secured into a recess 104 of the holder 100. A sampler 90 may be secured to the holder 100. A sampler 90 may be releaseably secured to the holder 100 which may be achieved in a number of ways, for example mechanically or with a drop of liquid (e.g., water) placed between the surface of the recess 104 and the undersurface of the sampler 90. The sampler 90 may be secured to the holder 100 by adhering the sampler 90 to the holder 100, for example, with glue. The sampler 90 may be secured to the holder 100 by direct contact between the respective mutually contacting surfaces 91, 101 (see FIG. 1I c) of the sampler 90 and the holder 100. Such a securing may be secure because the mutually contacting surfaces of the sampler 90 and the holder 100 may be made of the same material. The sampler 90 may be releaseably secured to the holder 100 by application of an under pressure through opening 106, for example as shown in FIGS. 11a, 11b and 11c where the applied under pressure is represented by an arrow 112.

FIG. 11a shows the surface of a recess 104. An opening 106 of a through-hole 108 is defined in the surface of the recess 104. The through-hole 108 passes through the holder 100, as shown in FIG. 11c. A contorted path 110 is formed, for example etched, in the surface of the recess. In the embodiment shown in FIG. 11a, the contorted path passes across the opening. In this example, the contorted path 110 may include a spiral feature; each limb may have a spiral feature. The contorted path increases the surface area over which the under pressure is applied, providing a stronger securing between the sampler 90 and the sample holder 100.

A further embodiment of the contorted path is shown in FIG. 11b. In this embodiment, the contorted path 110 may have two limbs. Each limb may connect with a through-hole 108. The contorted path 110 is substantially sinusoidal. The contorted path may have any shape or locus. It may be curved, angular, branched, circular or comprise two or more interconnected, concentric circles.

When the sampler 90 is held in the holder 100, an under pressure can be applied to the undersurface of the holder 100, and thus to the undersurface of the sampler 90, through the through-hole 108. The under pressure retains the sampler 90 in the holder 100. The force applied by the under pressure may be better applied (e.g., more evenly over the undersurface of the sampler) through two limbs of the contorted path than if the path simply connected to the through-hole and has one limb. It may be beneficial to optimize the contorted path 108 to have a short path length and yet maximize the surface area over which the under pressure would be applied during use. Alternatively or additionally, the contorted path 110 is formed in the under-surface of the sampler 90.

In FIG. 10 the samplers 90 are all substantially rectangular, however the samplers 90 may take any manner of shape, for example circular, triangular or in an arc. Such arc shaped samplers 90 may be fitted to the rim of a circular sample holder 100.

Having the sample holder 100 shaped and dimensioned as a substrate is desirable because a number of the components of the lithographic apparatus are configured to handle and manipulate an object of that size and shape. Such components include a substrate handler and a substrate cassette cache. A substrate is easily transported, for example in a carrier, so that the sample holder 100 may be carried in such a carrier. The carrier may comprise more than one substrate, so multiple sample holders may be used. This is desirable because it facilitates easy transport off-site for detailed inspection of the samples collected on the sample holders.

In addition, having different samplers 90 removeably fitted to the sample holder 100 means that the sample holder 100 can be used in place of the substrate in the immersion system or in the inspection tool, or both. For such a sample holder 100 to be used under the liquid confinement structure 12 during operation of the immersion system, each sampler 90 present in the sample holder 100 may be held sufficiently securely to prevent each sampler 90 from dislodging from a recess 104. A holder 100 with the shape and dimension of a substrate may be easy for a user to move, hold or manipulate.

Desirably the sampling surface 96 of the collector layer 92 is substantially co-planar and parallel with the surrounding surface 102 of the sample holder 100. The sampling surface 96 of the collector layer 92 may be flush with the adjacent portion of the surface 102 of the holder base 94. When one or more samplers 90 are present in a holder 100, samples of particles may be collected by the sampling surface 96 of each collector layer 92 present.

A sampler 90 may be positioned within the immersion system, such as up-stream of the immersion liquid supply inlet 13 or the immersion liquid inlet in liquid confinement structure 12, in or adjacent a gas knife or gas seal inlet, or upstream of an extractor outlet or an immersion liquid outlet 13. A sampler 90 may be positioned within the drain located in the gap 17 in the substrate table WT around the substrate. In immersion systems with an in-line cleaning system, one or more samplers 90 may be located upstream in the flow of liquid with respect to an inlet and downstream of an outlet to supply and remove cleaning fluid, respectively, to clean features of the immersion system. There may be a sampler 90 located at any combination of these locations. If appropriate, the samplers may be dimensioned and shaped to take samples in one or more of these locations. The recesses 104 in the sample holder 100 may be shaped and sized to accept these samplers 90.

Once the samples have been taken from the surface of an immersion system component, or from fluid flowing past the component, the sampler 90 may be removed. The sampler 90 may then be fitted to the sample holder 100 for inspection (or already be part of the sample holder 100). The sampler 90 may then be inspected.

The presence of particles in the immersion system is not just a problem of defectivity in immersion. Defectivity may have other sources of particle contaminants, such as a substrate handler which is used to position the substrate in position on the substrate table during substrate swap, a reticle handler which is used to manipulate and change a mask, or any other part of the lithographic apparatus or associated machines which may be a source of particles. A sampler 90 may be located in these other locations to collect a sample of particles.

Particles may be generated prior to installation of a component of a lithographic apparatus or of the lithographic apparatus itself. Before a component has been successfully fitted to a lithographic apparatus there may be a risk that the component has been contaminated with particles in transportation. Particles may contaminate a component from the moment the component is shipped until the moment it is installed. It is therefore beneficial to have a sampler 90 present with the component or lithographic apparatus during shipment, even within its packaging.

The sampler 90 is designed for sampling and inspecting contamination such as particles that may gather in an immersion lithographic apparatus. A sampler 90 may be placed in a position on the apparatus. If a sample is to be taken from a surface, the surface is swabbed by the sampler 90, by placing the sampling surface 96 of the collector layer 92 on the sample surface. If the sample is to be taken from a fluid (e.g., a liquid), the sampler 90 is placed in a position so that, while the immersion system is operated, a fluid flows across the sampling surface 96 of the collector layer 92. Once the sample has been collected, the sampler 90 is removed from the lithographic apparatus. It may then be placed in sample holder 100 (which may be substrate shaped). The sample holder 100 may contain samplers 90 with samples from different locations of the lithographic apparatus or immersion system. The samples may have been taken at different moments in time, for example they may comprise consecutive samples taken at specific time intervals or before and after servicing. The samples may be used to determine the defectivity problems present in the lithographic apparatus. The sampler 90 or holder 100 with sampler 90 may then be placed in an on-site inspection tool for examination. Analysis of a plurality of samplers 90 may show the change in the number and location of particles over time and the effect of servicing. Remedial measures may be taken as appropriate. An automated process may be used to move, manipulate and to process a sampler to sample samples.

An embodiment of the invention thus provides a simple sampler 90 which may be desirably used to monitor defectivity. Such defectivity monitoring may be made during installation, preventative maintenance, emergency maintenance or during normal operation. On-site defectivity monitoring readily permits a quick diagnosis of defectivity problems preventing significant damage to the lithographic apparatus. Use of an embodiment of the invention may assist in prolonging the lifetime of components and reduce the risk of damage to an immersion lithographic apparatus.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

While specific embodiments of the invention have been described above, it will be appreciated that the invention may be practiced otherwise than as described. For example, the invention may take the form of one or more computer programs containing one or more sequences of machine-readable instructions describing a method as disclosed above, or a data storage medium (e.g. semiconductor memory, magnetic or optical disk) having such a computer program stored therein. One or more controllers may be provided to control the apparatus, each controller having a processor. The controllers may operate the apparatus according to the one or more computer programs embodying the invention.

One or more embodiments of the invention may be applied to any immersion lithography apparatus, in particular, but not exclusively, those types mentioned above and whether the immersion liquid is provided in the form of a bath, is confined to a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The immersion liquid used in the apparatus may have different compositions, according to the desired properties and the wavelength of exposure radiation used. For an exposure wavelength of 193 nm, ultra pure water or water-based compositions may be used and for this reason the immersion liquid is sometimes referred to as water and water-related terms such as hydrophilic, hydrophobic, humidity, etc. may be used, although they should be considered more generically. It is intended that such terms should also extend to other high refractive index liquids which may be used, such as fluorine containing hydrocarbons.

The descriptions above are intended to be illustrative, not limiting. Thus, it will be apparent to one skilled in the art that modifications may be made to the invention as described without departing from the scope of the claims set out below.

1. A sampler configured to collect sample contaminants in a lithographic apparatus, the sampler comprising a holder base having a collector surface, the collector surface configured to collect and store contaminants.

2. The sampler of claim 1, wherein the sampler is substantially the height of a substrate for use in exposure by a lithographic apparatus.

3. The sampler of claim 1, wherein a major surface of the holder base has a smaller area than that of a major surface of a substrate for use in exposure by a lithographic apparatus.

4. The sampler of claim 1, wherein the holder base comprises a collector layer, the collector layer having the collector surface and being a sticker.

5. The sampler of claim 1, wherein the collector surface is made of a material selected so that the collector surface is arranged to collect particles having a specified size range and/or material.

6. The sampler of claim 1, wherein the holder base comprises silicon or carbon.

7. The sampler of claim 1, wherein the sampler is removeably securable to a sample holder, the sample holder having the shape and dimensions of a substrate for use in exposure by a lithographic apparatus.

8. The sampler of claim 1, wherein the sampler comprises only one layer.

9. A sample holder configured to hold releaseably a sampler configured to collect sample contaminants in a lithographic apparatus, the sampler comprising a holder base having a collector surface, the collector surface configured to collect and store contaminants.

10. The sample holder of claim 9 configured to hold a plurality of the samplers.

11. The sample holder of claim 9 dimensioned and shaped to be used in a lithographic exposure apparatus.

12. The sample holder of claim 9 dimensioned and shaped to be used in an on-site inspection tool.

13. The sample holder of claim 9, wherein the holder base is made of substantially the same material as the sample holder.

14. The sample holder of claim 9, wherein the holder base is mechanically securable to the sample holder.

15. The sample holder of claim 9, comprising a recess configured to receive the sampler.

16. The sample holder of claim 9, wherein the collector surface is substantially co-planar with a surface of the sample holder.

17. An immersion lithographic apparatus, comprising:
an immersion system; and
a removable sampler configured collect particles in the immersion system, the sampler comprising a holder base having a collector surface, the collector surface configured to collect and store contaminants,
wherein the sampler is removeably located on a surface of the immersion system so as to collect sample particles by contact of the collector surface with a liquid or with a surface of the immersion system or to collect falling or gas-borne particles.

18. The immersion lithographic apparatus of claim 17, comprising a plurality of samplers.

19. The immersion lithographic apparatus of claim 18, wherein each sampler is located on a different surface of the immersion lithographic apparatus.

20. The immersion lithographic apparatus of claim 17, wherein the liquid is immersion liquid.

21. The immersion lithographic apparatus of claim 17, wherein the immersion system comprises a substrate table configured to hold a substrate and a liquid supply system configured to supply liquid between a projection system and the substrate table or substrate.

22. The immersion lithographic apparatus of claim 21, wherein the sampler is dimensioned to fit between the liquid supply system and the substrate table in the absence of the substrate.

23. A lithographic apparatus comprising:
a substrate table configured to hold a substrate;
a projection system configured to project a patterned beam of radiation onto a target portion of the substrate; and
a sampler located on a surface of the apparatus, the sampler comprising a holder base having a collector surface, the collector surface configured to collect and store particles.

24. The lithographic apparatus of claim 23, wherein the sampler has the height of a substrate for use in exposure by a lithographic apparatus.

25. A method of taking particle samples in an immersion lithographic apparatus, the method comprising:
positioning a particle sampler having the height of a substantially planar substrate in or on an immersion lithographic apparatus, the sampler comprising a holder base having a collector surface, the collector surface configured to collect and store particles, wherein in positioning the sampler, the collector surface: is in contact with a surface of the immersion lithographic apparatus or liquid of the immersion lithographic apparatus; or is configured to collect falling or gas-borne particles; and
removing the sampler from the immersion lithographic apparatus to inspect if any particles were collected on the collector surface.
